(19) United States
(12) Patent Application Publication
(10) Pub. No.: US 2008/0296489 A1
(43) Pub. Date: Dec. 4, 2008

(54) Atom Probe Evaporation Processes

(76) Inventors: Jesse D. Olson, Madison, WI (US); Daniel R. Lenz, Stoughton, WI (US); Timothy R. Payne, Madison, WI (US)

Correspondence Address: PERKINS COIE LLP;PATENT-SEA, P.O. BOX 1247, SEATTLE, WA, 98111-1247, US

(21) Appl. No.: 11/997,145

(22) PCT Filed: Jul. 28, 2006
(86) PCT No.: PCT/US06/29324

§ 371 Date: May 30, 2008

Related U.S. Application Data
(60) Provisional application No. 60/703,412, filed on Jul. 28, 2005.

(51) Int. Cl. H01J 49/00

(52) U.S. Cl. 250/286; 250/282

(57) ABSTRACT

The present invention relates to atom probe evaporation processes. For example, certain aspects are directed toward methods for controlling an evaporation process in an atom probe that includes initiating the atom probe evaporation process and monitoring a parameter associated with material being evaporated from a specimen. The method can further include controlling at least one characteristic of the atom probe evaporation process to attain a desired evaporation rate or characteristic. In selected embodiments, monitoring a parameter associated with material being evaporated can include monitoring an evaporation rate, mass-to-charge ratios of evaporated ions, a mass resolution, a composition of material being evaporated, and/or the like. In certain embodiments, controlling at least one characteristic can include controlling a pulse energy, a pulse frequency, a bias energy, and/or the like. In other embodiments, various portions of the above process can be computer implemented.

### CROSS-REFERENCE TO RELATED APPLICATION(S)

This application claims the benefit of U.S. Provisional Patent Application No. 60/703,412, filed Jul. 28, 2005, entitled ATOM PROBE EVAPORATION CONTROL, which is fully incorporated herein by reference.

### TECHNICAL FIELD

Embodiments of the present invention relate to atom probe evaporation processes, including methods for controlling evaporation rates and related characteristics in atom probe devices (e.g., atom probe microscopes).

### BACKGROUND

An atom probe (e.g., atom probe microscope) is a device which allows specimens to be analyzed on an atomic level. For example, a typical atom probe includes a specimen mount, an electrode, and a detector. During analysis, a specimen is carried by the specimen mount and a positive electrical charge (e.g., a baseline voltage) is applied to the specimen. The detector is spaced apart from the specimen and is negatively charged. The electrode is located between the specimen and the detector, and is either grounded or negatively charged. A positive electrical pulse (above the baseline voltage) and/or a laser pulse (e.g., photonic energy) are intermittently applied to the specimen. Alternately, a negative pulse can be applied to the electrode. Occasionally (e.g., one time in 100 pulses) a single atom is ionized near the tip of the specimen. The ionized atom(s) separate or “evaporate” from the surface, pass though an aperture in the electrode, and impact the surface of the detector. The elemental identity of an ionized atom can be determined by measuring its time of flight between the surface of the specimen and the detector, which varies based on the mass/charge ratio of the ionized atom. The location of the ionized atom on the surface of the specimen can be determined by measuring the location of the atom's impact on the detector. Accordingly, as the specimen is evaporated, a three-dimensional map of the specimen's constituents can be constructed.

Evaporation rate (Er), the number of ions detected per unit pulse, is a primary metric used to control/monitor the atom probe data collection process. Failure to accurately monitor or control Er can result in either little or no data being collected (Er˜0) or too many ionization events detected. Additionally, if the induced field is too great, the specimen can fracture, damaging the specimen and possibly other atom probe components. Furthermore, if the Er is too high where multiple ions are liberated or evaporated on the same pulse, data “noise” can result because the detected ions cannot be properly correlated in time with the ionizing pulse. This can lead to mass resolution problems and data degradation. Many classical atom probe methods use only a global evaporation rate parameter to regulate the specimen voltage and govern how aggressively to evaporate the sample. This may not be ideal for some atom probe process (e.g., where the specimen has a heterogeneous composition or where the specimen is highly faceted).

### SUMMARY

The present invention is directed generally toward atom probe evaporation processes. One aspect of the invention is directed toward a method for controlling an evaporation process in an atom probe that includes initiating the atom probe evaporation process of a specimen and monitoring a parameter associated with material being evaporated from a selected portion of a field of view of the specimen during the atom probe evaporation process. The selected portion of the field of view is less than the entire field of view. The method can further include controlling at least one characteristic of the atom probe evaporation process to attain at least approximately a desired evaporation rate for the selected portion.

Another aspect of the invention is directed toward a method for controlling an evaporation process in an atom probe that includes initiating the atom probe evaporation process of a specimen to evaporate material from the specimen. The material being evaporated results in ions hitting a detector. The method further includes monitoring mass-to-charge ratios of the detected ions and determining if any of the mass-to-charge ratios being monitored are at least approximately equal to one or more selected values. The method still further includes controlling at least one characteristic of the atom probe evaporation process to attain at least approximately a desired evaporation rate based on the mass-to-charge ratios being monitored.

Still another aspect of the invention is directed toward a method for controlling an evaporation process in an atom probe that includes initiating the atom probe evaporation process of a specimen to evaporate material from the specimen and establishing at least approximately a first evaporation rate. The method further includes reducing a pulse energy being applied to the specimen from a first pulse energy value associated with the first evaporation rate to a second pulse energy value. The method still further includes decreasing a bias energy being applied to the specimen from a first bias energy value associated with the first evaporation rate to a second bias energy value associated with a second evaporation rate.

Yet another aspect of the invention is directed toward a method for controlling an evaporation process in an atom probe that includes evaporating material from a specimen during the atom probe evaporation process at a first evaporation rate and a first value of a pulse fraction. The method further includes monitoring a parameter associated with material being evaporated from the specimen during the atom probe evaporation process. The method still further includes evaporating material from the specimen at a second evaporation rate with a second value of the pulse fraction. The second value is different than the first.

Still another aspect of the invention is directed toward a method for controlling an evaporation process in an atom probe that includes evaporating material from a specimen during the atom probe evaporation process at a first evaporation rate and a first value of a pulse frequency. The method further includes monitoring a parameter associated with material being evaporated from the specimen during the atom probe evaporation process. The method still further includes evaporating material from the specimen at a second evaporation rate with a second value of the pulse frequency. The second value is different than the first.

Yet another aspect of the invention is directed toward a computer implemented method for controlling an evaporation process in an atom probe that includes receiving multiple selected values for setting a pulse fraction in an atom probe and controlling the atom probe to produce the pulse fraction associated with each of the selected values. The method further includes monitoring a parameter associated with an evaporation of material from a specimen for each of the produced pulse fractions.

Still another aspect of the invention is directed toward a method for controlling an evaporation process in an atom probe that includes introducing a selected amount of a gas into an analysis chamber of an atom probe to lower the energy required to evaporate material from a specimen during an atom probe evaporation process. The method further includes running an atom probe evaporation process and evaporating material from the specimen.

Yet another aspect of the invention is directed toward a method for controlling an evaporation process in an atom probe that includes initiating the atom probe evaporation process of a specimen, evaporating material from the specimen, and varying a bias voltage to at least approximately maintain a first evaporation rate. The method further includes monitoring a parameter associated with material being evaporated from the specimen at the at least approximately the first evaporation rate and varying at least one of a pulse fraction, pulse energy, or pulse frequency to maintain at least approximately a second evaporation rate.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a partially schematic illustration of an atom probe device that includes an atom probe assembly with an atom probe electrode in accordance with embodiments of the invention.

FIG. 2 is a partially schematic illustration of a field of view of a specimen with a portion of the field of view including noncontiguous sections in accordance with certain embodiments of the invention.

FIG. 3 is a flow diagram illustrating a process for controlling an evaporation process in an atom probe in accordance with certain embodiments of the invention.

FIG. 4 is a flow diagram illustrating a process for controlling an evaporation process in an atom probe in accordance with selected embodiments of the invention.

FIG. 5 is a flow diagram illustrating a process for controlling an evaporation process in an atom probe in accordance with certain embodiments of the invention.

FIG. 6 is a partially schematic illustration of a photon emitter in accordance with selected embodiments of the invention.

FIG. 7 is a partially schematic illustration of a photon emitter in accordance with other embodiments of the invention.

FIG. 8 is a partially schematic illustration of a photon emitter in accordance with still other embodiments of the invention.

FIG. 9 is a partially schematic illustration of a specimen and a photon emission having a first polarity in accordance with selected embodiments of the invention.

FIG. 10 is a partially schematic illustration of the specimen shown in FIG. 9 with a photon emission having a second polarity in accordance with other embodiments of the invention.

FIG. 11 is a flow diagram illustrating a process for controlling an evaporation process in an atom probe in accordance with certain embodiments of the invention.

FIG. 12 is a flow diagram illustrating a process for controlling an evaporation process in an atom probe in accordance with selected embodiments of the invention.

FIG. 13 is a flow diagram illustrating a process for controlling an evaporation process in an atom probe in accordance with certain embodiments of the invention.

FIG. 14 is a flow diagram illustrating a process for controlling an evaporation process in an atom probe in accordance with selected embodiments of the invention.

FIG. 15 is a flow diagram illustrating a process for controlling an evaporation process in an atom probe in accordance with certain embodiments of the invention.

### DETAILED DESCRIPTION

In the following description, numerous specific details are provided in order to give a thorough understanding of embodiments of the invention. One skilled in the relevant art will recognize, however, that the invention may be practiced without one or more of the specific details, or with other methods, components, materials, etc. In other instances, well known structures, materials, or operations are not shown or described in order to avoid obscuring aspects of the invention.

References throughout the specification to “one embodiment” or “an embodiment” means that a particular feature, structure, or characteristic described in connection with the embodiment is included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

Accordingly, various embodiments of the invention are described below. First, the structure and operation of atom probe devices are discussed. Then, various methods for controlling an evaporation process and/or characteristics associated with an evaporation process in accordance with embodiments of the invention are described. These methods and processes are suitable for use in an atom probe having features similar to those described with reference to the structure and operation of atom probe devices.

### A. Atom Probe Devices

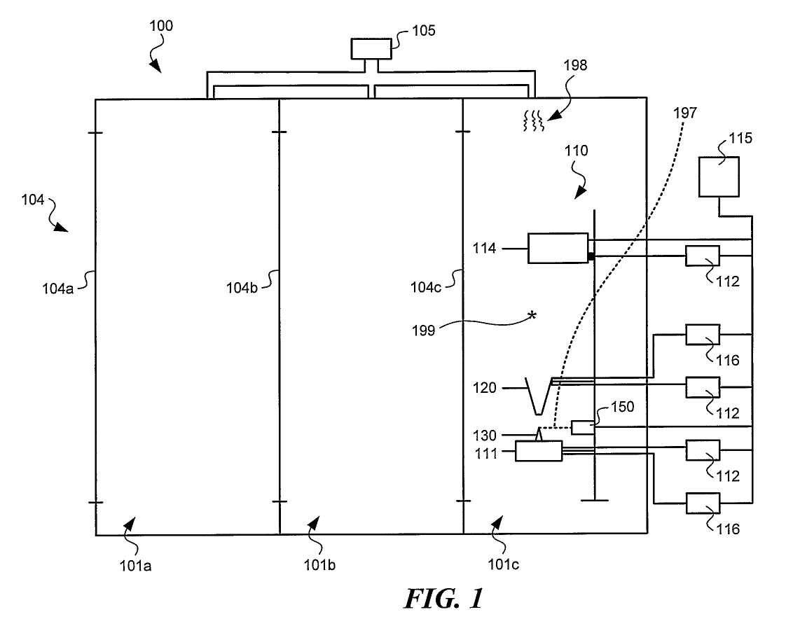

FIG. 1 is a partially schematic illustration of an atom probe device 100 in accordance with embodiments of the invention. In the illustrated embodiment, the atom probe device 100 includes a load lock chamber 101a, a buffer chamber 101b, and an analysis chamber 101c (shown collectively as chambers 101). The atom probe device 100 also includes a computer 115 and an atom probe assembly 110 having a specimen mount 111, an atom probe electrode 120, a detector 114, and an emitting device 150 (e.g., an emitting device configured to emit laser or photonic energy). The mount 111, electrode 120 and detector 114 can be operatively coupled to electrical sources 112. The electrode 120 and mount 111 can also be operatively coupled to temperature control devices 116 (e.g., cold/hot fingers that can provide contact cooling/heating to the atom probe electrode 120 and/or a specimen 130 carried by the mount 111). The emitting device 150, the detector 114, the voltage sources 112, and the temperature control devices 116 can be operatively coupled to the computer 115, which can control the analysis process, atom probe device operation, data analysis, and/or an image display.

In the illustrated embodiment, each chamber 101 is operatively coupled to a fluid control system 105 (e.g., a vacuum pump, turbo molecular pump, and/or an ion pump) that is capable of lowering the pressure in the chambers 101 individually. Additionally, the atom probe device 100 can include sealable passageways 104 (e.g., gate valves) positioned in the walls 106 of the chambers 101 that allow items to be placed in, removed from, and/or transferred between the chambers 101. In the illustrated embodiment, a first passageway 104a is positioned between the interior of the load lock chamber 101a and the exterior of the atom probe device 100, a second passageway 104b is positioned between the interior of the load lock chamber 101a and the interior of the buffer chamber 101b, and a third passageway 104c is positioned between the interior of the buffer chamber 101b and the interior of the analysis chamber 101c.

In FIG. 1, a specimen can be placed in the load lock chamber 101a via the first passageway 104a. All of the passageways 104 can be sealed and the fluid control system 105 can lower the pressure in the load lock chamber 101a (e.g., reduce the pressure to 10⁻⁶-10⁻⁷ torr). The pressure in the buffer chamber 101b can be set at approximately the same or a lower pressure than the load lock chamber 101a. The second passageway 104b can be opened, the specimen 130 can be transferred to the buffer chamber 101b, and the second and third passageways 104b and 104c can be sealed.

The fluid control system 105 can then lower the pressure in the buffer chamber 101b (e.g., reduce the pressure to 10⁻⁸-10⁻⁹ torr). The pressure in the analysis chamber 101c can be set at approximately the same or a lower pressure than the buffer chamber 101b. The third passageway 104c can be opened, the specimen 130 can be transferred to the analysis chamber 101c, and the third passageway 104c can be sealed. The fluid control system 105 can then reduce the pressure in the analysis chamber 101c (e.g., the pressure can be lowered to 10⁻¹⁰-10⁻¹¹ torr) prior to analysis of the specimen 130. In the illustrated embodiment, the fluid control system 105 can also be used to introduce selected fluids 198 (e.g., gases and/or liquid) and/or to control the composition of fluid in various atom probe chambers 110.

During analysis of the specimen 130, a positive electrical charge (e.g., a bias voltage or bias energy) can be applied to the specimen. The detector can be negatively charged and the electrode can be either grounded or negatively charged. A positive electrical pulse (e.g., an increase above the baseline energy or voltage) can be intermittently applied to the specimen 130 or a negative electrical pulse can be applied to the electrode 120. The electric field(s) created by the electrical charges can provide energy to ionize one or more atom(s) on the surface of the specimen 130. These ionized atom(s) 199 can separate or “evaporate” from the surface, pass though an aperture in the electrode 120, and impact the surface of the detector 114. As the specimen 130 is evaporated, a three-dimensional map of the specimen's constituents can be constructed. In other embodiments, the bias energy can include the energy difference (e.g., electrical potential) between the specimen and the detector and/or the electrode when no pulse energy is present.

In certain embodiments, laser or photonic energy from the emitting device 150 can be used to emit an emission 197 (e.g., photons or laser light) to thermally pulse a portion of the specimen 130 to assist with the evaporation process (e.g., the removal of ionized atoms). This laser pulse can be in lieu of the electrical pulse discussed above or in addition to the electrical pulse. The total energy above the bias energy (e.g., a laser pulse, an electrical pulse, an electron beam or packet, an ion beam, or some other suitable pulsed energy source) represents the pulse energy. The rate at which the pulse energy is applied is the pulse frequency.

In other embodiments, the atom probe device 100 can have more, fewer, and/or other arrangements of components. For example, in certain embodiments the atom probe device 100 can include more or fewer chambers, or no chambers. In other embodiments, the atom probe device can include multiple atom probe electrodes 120 and/or electrode(s) 120 having different configurations/placements (e.g., planar electrode(s)). In still other embodiments, the atom probe device 100 includes more, fewer, or different emitting devices 150; more, fewer, or different temperature control systems 116; and/or more, fewer or different electrical sources 112.

### B. Evaporation Processes and Associated Characteristics

The pulse fraction is an important parameter in the atom probe data collection process. Pulse fraction is proportional to the ratio of the pulse energy (e.g., the time-varying pulse) divided by the specimen bias energy (e.g., voltage). As discussed above, failure to accurately record the specimen bias voltage and pulse fraction for the detected ions can result in mass resolution degradation and/or errors in compositional assignments during data analysis. Additionally, during atom probe analysis of materials with heterogeneous composition sudden upsurges in evaporation rate may occur as different material interfaces are revealed. When this occurs, specimen fracture may result if the evaporation rate cannot be controlled quickly enough. Various embodiments discussed below include methods for controlling an evaporation process and/or controlling characteristic(s) associated with an evaporation process. Many or all of these methods/processes are discussed below in the context of using an atom probe device with features similar to those described above with reference to FIG. 1.

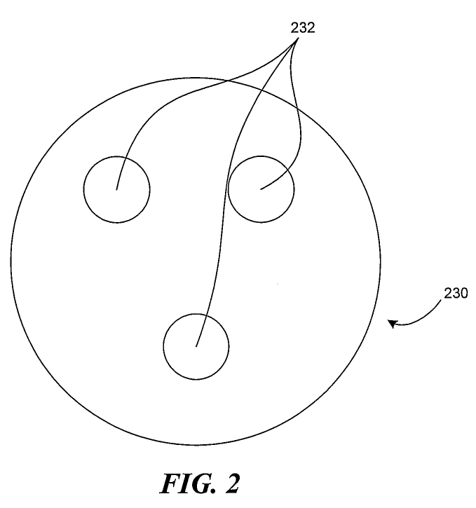

For example, in a selected embodiment an evaporation rate can be is calculated for a local area or portion of a specimen. For instance, in certain embodiments a specimen can be divided into multiple sections and the Er or related characteristic in one or more of the sections can be monitored. In selected embodiments a section having a high or low Er can be continually monitored during specimen analysis. This monitored Er rate can be a basis for controlling characteristics of the evaporation process (e.g., via the computer or computing system shown in FIG. 1). If the specimen includes various layers, the section(s) that are being monitored can change as different layers are revealed during the analysis process. In certain embodiments, this process can result in better mass resolution, better data quality, improved specimen life, and the like. As shown in FIG. 2, in selected embodiments ions detected from a portion 232 of the entire field-of-view 230 (FOV) of the specimen can be monitored and used to calculate the Er rather than using ions detected over the entire FOV. In some embodiments, the portion can include multiple noncontiguous sections.

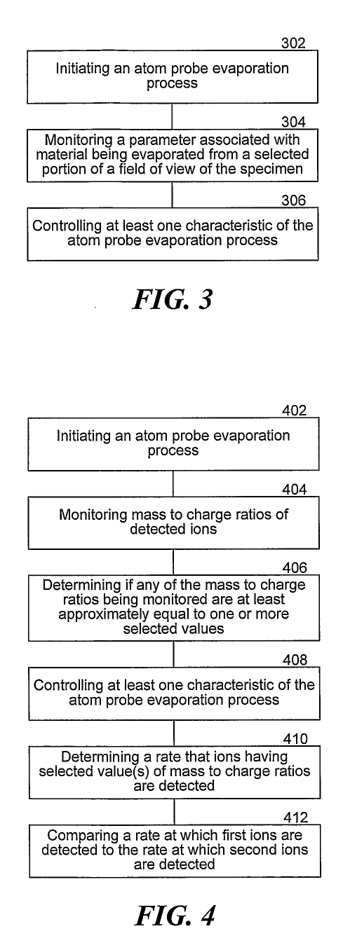

FIG. 3 is a flow diagram illustrating a process for controlling an evaporation process in an atom probe in accordance with certain embodiments of the invention. The process can include initiating an atom probe evaporation process (process portion 302), monitoring a parameter associated with material being evaporated from a selected portion of a field of view of the specimen (process portion 304), and controlling at least one characteristic of the atom probe evaporation process (process portion 306).

For example, in certain embodiments a method for controlling an evaporation process in an atom probe can include initiating the atom probe evaporation process of a specimen and monitoring a parameter associated with material being evaporated from a selected portion of a field of view of the specimen during the atom probe evaporation process. The selected portion of the field of view is less than the entire field of view. The method can further include controlling at least one characteristic of the atom probe evaporation process to attain at least approximately a desired evaporation rate for the selected portion. In selected embodiments, the selected portion of the field of view can include a first section and a second section spaced apart from the first section, wherein the first and second sections are noncontiguous.

In certain embodiments a computing system (e.g., as shown in FIG. 1) can be used to monitor the parameter associated with material being evaporated from a selected portion of a field of view of the specimen during the atom probe evaporation process. Additionally, in certain embodiments the computing system can be used to automatically control or adjust the characteristic(s) based on the parameter associated with material being evaporated. In some embodiments, the computing system can be a distributed computing system and include multiple components having varying locations.

In selected embodiments, controlling at least one characteristic of the atom probe evaporation process can include controlling a pulse energy, a pulse frequency, a bias energy, and/or any other parameter that can affect the evaporation process. In certain embodiments, monitoring a parameter associated with material being evaporated from a selected portion of the field of view of the specimen can include monitoring the evaporation rate of the material being evaporated from the selected portion of the field of view of the specimen, a mass resolution for the selected portion of the field of view of the specimen, a composition of the material being evaporated from the selected portion of the field of view of the specimen, and/or the like. In still other embodiments, the material being evaporated from the specimen can include a first type of material and a second type of material. Monitoring a parameter associated with material being evaporated can include monitoring a rate that the first type of material is being evaporated from the selected portion of the field of view of the specimen and/or monitoring the rate that the first type of material is being evaporated as compared to the rate that the second type of material is being evaporated.

In certain embodiments, material being evaporated from the specimen results in ions hitting a detector (e.g., similar to the detector shown in FIG. 1). Monitoring a parameter associated with material being evaporated from a selected field of view of the specimen can include monitoring mass-to-charge ratios of the detected ions and determining if any of the mass-to-charge ratios being monitored are at least approximately equal to one or more selected values (e.g., determining if any of the mass-to-charge ratios falls within one or more selected ranges). In other embodiments, monitoring a parameter associated with evaporation can include determining a rate that ions having mass-to-charge ratios at least approximately equal to one or more selected values are detected by the detector. In still other embodiments, the material being evaporated results in first ions hitting a detector and second ions hitting the detector. The first ions have a first mass-to-charge ratio and the second ions having a second mass-to-charge ratio. Monitoring a parameter associated with evaporation can include comparing a rate at which the first ions are detected by the detector to the rate at which the second ions are detected by the detector.

In other embodiments of the invention, the composition of the material being collected (e.g., evaporated from the specimen) can be considered or monitored and the Er can be controlled based on the composition of material detected. For example, different materials exhibit different evaporation potentials and preferential evaporation can occur if the pulse fraction is not carefully controlled (see e.g., Miller, Atom Probe Tomography, which is fully incorporated herein by reference). Accordingly, in selected embodiments the target evaporation rate and/or pulse fraction can be adjusted upon detection of a compositional change in the specimen as the specimen is evaporated. In certain embodiments, a compositional change can be indicated by a change in the ions being detected (e.g., a change in the mass-to-charge ratio of the ions being detected).

For example, in certain embodiments the pulse energy can be adjusted based on ions detected within specific mass-to-charge (m/q) range(s) (e.g., multiple selected values). In one embodiment, the count of m/q values within a selected range (e.g., a count over a period of time or a rate) can be monitored and the pulse energy can be controlled based on this count or rate. In another embodiment, the rate that specific m/q value(s) are detected can be monitored (e.g. Si+; or Si+, Si++, and Si+++) and the pulse energy can be controlled based on this rate. In some circumstances, this feature can improve specimen survival.

FIG. 4 is a flow diagram illustrating a process for controlling an evaporation process in an atom probe in accordance with selected embodiments of the invention. The process can include initiating an atom probe evaporation process (process portion 402) and monitoring mass-to-charge ratios of detected ions (process portion 404). The process can further include determining if any of the mass-to-charge ratios being monitored are at least approximately equal to one or more selected values (process portion 406) and controlling at least one characteristic of the atom probe evaporation process (process portion 408). In certain embodiments, the process can still further include determining a rate (e.g., a count over a period of time) that ions having selected value(s) of mass-to-charge ratios are detected (process portion 410) and/or comparing a rate at which first ions are detected to the rate at which second ions are detected (process portion 412).

For example, in selected embodiments a method for controlling an evaporation process in an atom probe can include initiating the atom probe evaporation process of a specimen to evaporate material from the specimen. The material being evaporated results in ions hitting a detector. The method can further include monitoring mass-to-charge ratios of the detected ions and determining if any of the mass-to-charge ratios being monitored are at least approximately equal to one or more selected values. The method can still further include controlling at least one characteristic of the atom probe evaporation process to attain at least approximately a desired evaporation rate based on the mass-to-charge ratios being monitored.

In selected embodiments, the method can still further include determining a rate that ions having mass-to-charge ratios at least approximately equal to one or more selected values are detected by the detector. In other embodiments, the material being evaporated results in first ions hitting a detector and second ions hitting the detector. The first ions have a first mass-to-charge ratio at least approximately equal to a first selected value and the second ions have a second mass-to-charge ratio at least approximately equal to a second selected value. The method can still further include comparing a rate at which the first ions are detected by the detector to the rate at which the second ions are detected by the detector.

In certain embodiments, controlling at least one characteristic of the atom probe evaporation process can include controlling a pulse energy, a pulse frequency, and/or a bias energy. In still other embodiments, a computing system can be used to monitor mass-to-charge ratios of the detected ions, to determine if any of the mass-to-charge ratios being monitored are at least approximately equal to one or more selected values, and to control at least one characteristic of the atom probe evaporation process to attain at least approximately a desired evaporation rate based on the mass-to-charge ratios being monitored.

In other embodiments of the invention, once a need to change (e.g., reduce) an Er is determined, a pulse energy can be reduced before a changing (e.g., reducing) the bias energy so that the specimen is not subject to unnecessarily high electric fields (or thermal excitation) longer than needed. In some instances, this feature can reduce the likelihood of specimen fracture. In addition, in selected embodiments the pulse energy is not re-triggered until bias energy settles and/or the specimen achieves thermal equilibrium. In some circumstances, waiting for the voltage to settle can improve the mass resolution by decreasing the spread in ion departure times that results from a finite pulse width. In certain embodiments, an equivalent effect can occur with laser pulsing (e.g., for a shorter time and via a different mechanism).

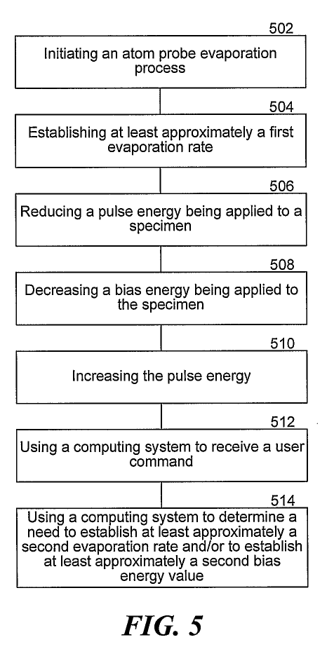

FIG. 5 is a flow diagram illustrating a process for controlling an evaporation process in an atom probe in accordance with certain embodiments of the invention. The process can include initiating an atom probe evaporation process (process portion 502) and establishing at least approximately a first evaporation rate (process portion 504). The method can further include reducing a pulse energy being applied to a specimen (process portion 506) and decreasing a bias energy being applied to the specimen (process portion 508). In selected embodiment, the process can further include increasing the pulse energy (process portion 510). In other embodiments, the process can still further include using a computing system to receive a user command (process portion 512), for example, to establish at least approximately the second evaporation rate and/or to establish at least approximately the second bias energy value. In still other embodiments, the process can yet further include using a computing system to determine a need to establish at least approximately a second evaporation rate and/or to establish at least approximately a second bias energy value (process portion 514).

For example, in selected embodiments a method for controlling an evaporation process in an atom probe can include initiating the atom probe evaporation process of a specimen to evaporate material from the specimen and establishing at least approximately a first evaporation rate. The method can further include reducing a pulse energy being applied to the specimen from a first pulse energy value associated with the first evaporation rate to a second pulse energy value (e.g., in selected embodiments the second pulse energy value can be zero). The method can still further include decreasing a bias energy being applied to the specimen from a first bias energy value associated with the first evaporation rate to a second bias energy value associated with a second evaporation rate. In selected embodiments, the method can still further include increasing the pulse energy from at least approximately the second pulse energy value to a third pulse energy value after the bias energy has been established (e.g. settled or stabilized) at the second bias energy value, wherein the third pulse energy value is associated with the second evaporation rate.

In selected embodiments, the bias energy can include a bias voltage. In other embodiments, the pulse energy can include an electrical pulse and/or a photonic energy pulse. In certain embodiments, the second evaporation rate is less than the first evaporation rate. In other embodiments, the second evaporation rate is at least approximately the same as the first evaporation rate. In still other embodiments, the second evaporation rate is greater than the first evaporation rate.

In still other embodiments, a computing system can be used to (1) establishing at least approximately a first evaporation rate, (2) receive a user command to establish at least approximately the second evaporation rate and/or to establish at least approximately the second bias energy value, (3) determine a need to establish at least approximately the second evaporation rate and/or to establish at least approximately the second bias energy value, (4) automatically reduce a pulse energy being applied to the specimen in response to the user command, (5) automatically decrease a bias energy based on the user command, and/or (6) increase the pulse energy from at least approximately the second pulse energy value to a third pulse energy value after the bias energy has been established at the second bias energy value, wherein the third pulse energy value is associated with the second evaporation rate.

In selected embodiments, the pulse energy can include photonic energy and reducing a pulse energy being applied to the specimen can include preventing at least a portion of the photonic beam from reaching the specimen. For example, in certain embodiments, reducing the pulse energy can include turning off the photonic energy emissions, blocking at least a portion of a photonic beam, modulating a polarity of at least a portion of the photonic beam, steering at least a portion of the photonic beam away from the specimen, and/or defocusing at least a portion of the photonic beam.

When using a regenerative amplifier to generate photonic energy, a pulse interruption (e.g., an optical switch stopping emissions) can, in some cases, results in saturation within an amplification cavity. Accordingly, in certain situations, when the pulse is re-triggered, the first pulse can be many times the previous pulse's power level and can result in specimen fracture. Therefore, in selected embodiments it can be advantageous to block a portion of the beam, redirect a portion of the beam, defocus a portion of the beam, and/or modulate the polarity of the beam without interrupting the emission generation process.

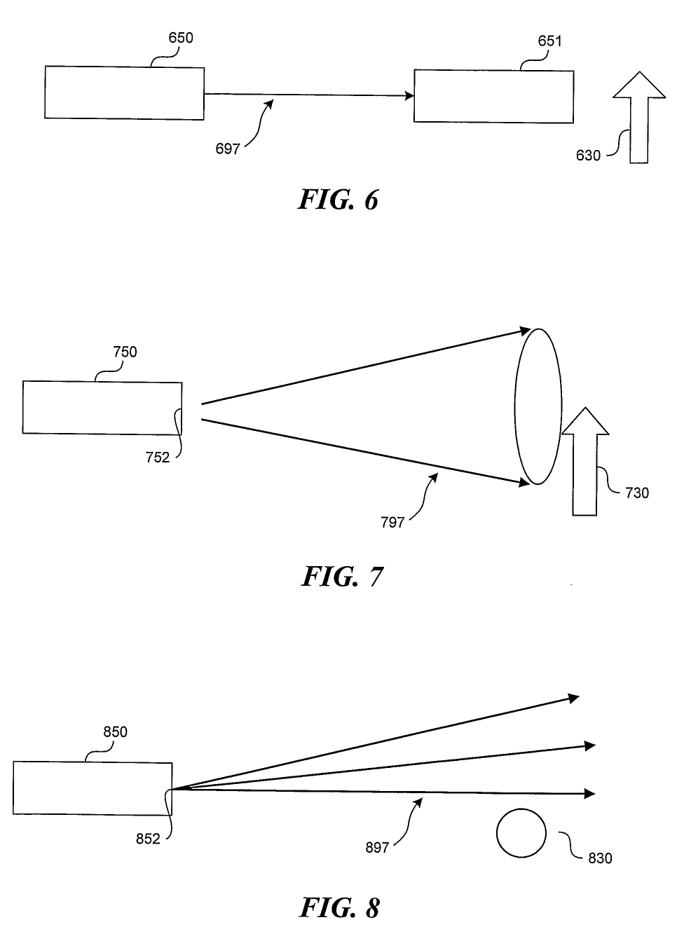

For example, as shown in FIG. 6, a photon emitter 650 (e.g., similar to selected embodiments of the emitter 150 shown in FIG. 1) is positioned to emit a photonic emission 697 toward a specimen 630. An occlusion device 651 is positioned so that it can block at least a portion of the photonic emission 697 to reduce the pulse energy. In selected embodiments, the occlusion device 651 can include a shutter device or device that can change transmissivity (e.g., having at least two settings wherein a first setting allows less photonic energy to pass through the device than does a second setting). In other embodiments, the occlusion device 651 can include a beam blanking device (e.g., with Pockels cell).

FIG. 7 is a partially schematic illustration of a photon emitter 750 in accordance with other embodiments of the invention. In FIG. 7, the photon emitter 750 includes a focusing mechanism 752. The focusing mechanism 752 can defocus or spread out the photon emission 797 produced by the photon emitter, thereby reducing the photonic energy received by the specimen 730 (e.g., reducing the pulse energy).

FIG. 8 is a partially schematic illustration of a photon emitter 850 in accordance with still other embodiments of the invention. In FIG. 8, the photon emitter 850 includes a steering mechanism 852. To reduce the pulse energy, the steering mechanism 852 steers or aims the photonic emission 897 away from a specimen 830, thereby reducing the pulse energy received by the specimen 830.

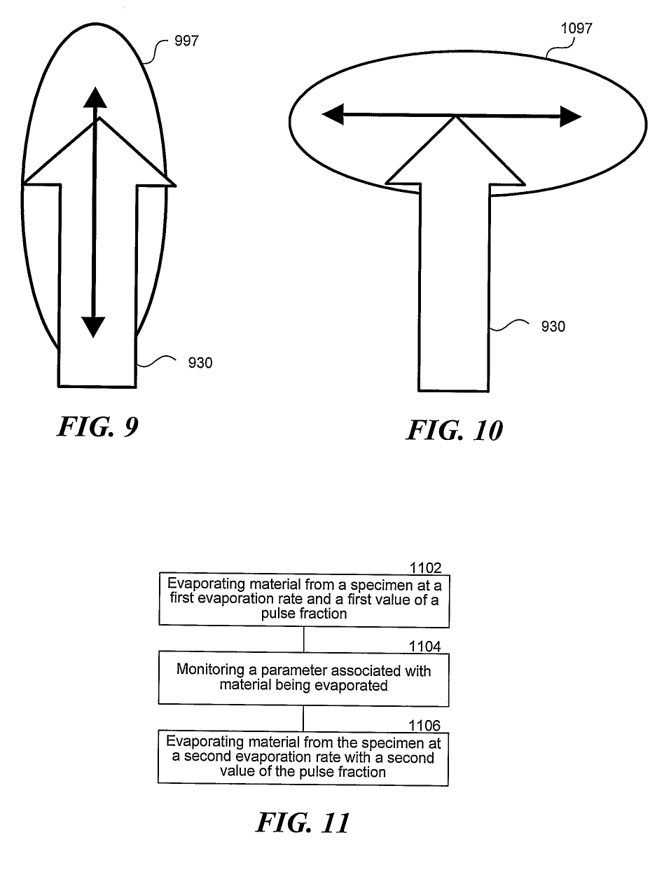

FIG. 9 is a partially schematic illustration of a specimen 930 and a photon emission 997 having a first polarity in accordance with selected embodiments of the invention. In FIG. 9, the first polarity is oriented at least approximately parallel to a long axis of the specimen 930. Accordingly, the specimen 930 receives a desired amount of pulse energy each time the associated photon emitter is pulsed.

FIG. 10 is a partially schematic illustration of the specimen 930 shown in FIG. 9 with a photon emission 1097 having a second polarity in accordance with other embodiments of the invention. In FIG. 10, the second polarity is oriented at least approximately perpendicular to a long axis of the specimen and is received by a smaller portion of the specimen 930. Accordingly, the pulse energy is reduced as compared to that received in FIG. 9.

In yet other embodiments of the invention, a pulse fraction can be modulated in response to a parameter derived from acquired or collected data. Typically, using current methods, the pulse fraction is kept constant during the course of an atom probe measurement, with the amplitude of the pulse energy scaling appropriately as the bias voltage is adjusted. In selected embodiments, the mass resolution or other parameter can be monitored and the pulse fraction can be changed in response to the collected data. In some embodiments, this feature can be particularly well suited for analyzing non-uniform materials with multiple work functions and/or multi-layered specimens. The ability to vary the pulse fraction may allow certain materials to be analyzed more quickly, more accurately (e.g., with better mass resolution), and with greater success. For example, in some embodiments when analyzing a homogenous volume/layer, higher pulse fractions may be used to aggressively evaporate the material/layer and when transitioning through an interface (e.g., between two layers of different material) a smaller pulse fraction may be more effective.

FIG. 11 is a flow diagram illustrating a process for controlling an evaporation process in an atom probe in accordance with certain embodiments of the invention. The process can include evaporating material from a specimen at a first evaporation rate and a first value of a pulse fraction (process portion 1102) and monitoring a parameter associated with material being evaporated (process portion 1104). The process can further include evaporating material from the specimen at a second evaporation rate with a second value of the pulse fraction (process portion 1106).

For example, in selected embodiments a method for controlling an evaporation process in an atom probe can include evaporating material from a specimen during the atom probe evaporation process at a first evaporation rate and a first value of a pulse fraction. The method can further include monitoring a parameter associated with material being evaporated from the specimen during the atom probe evaporation process. The method can still further include evaporating material from the specimen at a second evaporation rate with a second value of the pulse fraction, wherein the second value is different than the first (e.g., establishing the second rate when a transition between layers is indicated by the monitored parameter).

In selected embodiments, the first evaporation rate is at least approximately equal to the second evaporation rate. In other embodiments the first evaporation rate is different from the second evaporation rate. In certain embodiments, monitoring a parameter can include monitoring the evaporation rate of the material being evaporated from the specimen, a mass resolution for the specimen, and/or a composition of the material being evaporated from the specimen.

In still other embodiments, the material being evaporated can include a first type of material and a second type of material, and monitoring a parameter can include monitoring a rate that the first type of material is being evaporated from the specimen and/or monitoring the rate that the first type of material is being evaporated as compared to the rate that the second type of material is being evaporated. In yet other embodiments, a computing system can be used to monitor a parameter associated with material being evaporated from the specimen during the atom probe evaporation process and/or to automatically change the pulse fraction from the first value to the second value (e.g., in response to the monitored parameter(s)).

In other embodiments of the invention, the value of the pulse fraction can be changed or swept through a range to determine a desired value (e.g., a value that provides a desired affect or result). An output parameter such as mass resolution or Er can be monitored while the pulse fraction is adjusted. An optimal operating range (e.g., multiple selected values) can be established based on the results of the sweep.

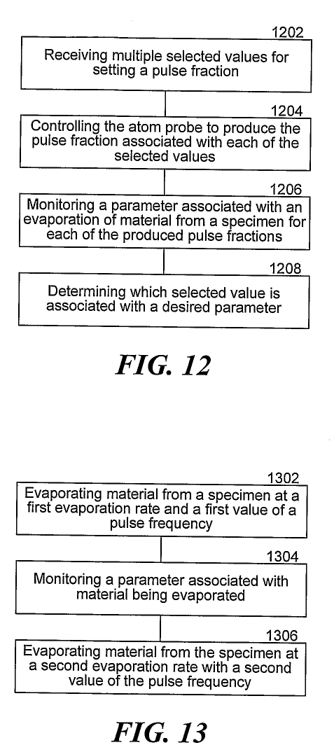

FIG. 12 is a flow diagram illustrating a process for controlling an evaporation process in an atom probe in accordance with selected embodiments of the invention. The process can include receiving multiple selected values for setting a pulse fraction (process portion 1202) and controlling the atom probe to produce the pulse fraction associated with each of the selected values (process portion 1204). The process can further include monitoring a parameter associated with an evaporation of material from a specimen for each of the produced pulse fractions (process portion 1206). In selected embodiments, the method can still further include determining which selected value is associated with a desired parameter (process portion 1208).

For example, in selected embodiments a computer implemented method for controlling an evaporation process in an atom probe includes receiving multiple selected values for setting a pulse fraction in an atom probe and controlling the atom probe to produce the pulse fraction associated with each of the selected values. The method further includes monitoring a parameter associated with an evaporation of material from a specimen for each of the produced pulse fractions.

In selected embodiments, the method can still further include determining which selected value is associated with a desired parameter. In certain embodiments, monitoring a parameter can include monitoring an evaporation rate associated with material being evaporated from a specimen and/or a mass resolution associated with material being evaporated from a specimen. In certain embodiments, the parameter associated with an evaporation of a material and/or an evaporation rate can include an evaporation rate of zero.

In yet other embodiments of the invention, a pulse frequency, pulse rate, or pulse trigger frequency can be adjusted while monitoring selected output parameter(s). For example, a low pulse frequency can be selected to gently initiate field evaporation while monitoring Er, or to achieve a desired mass resolution while analyzing a particular region. Conversely a high pulse frequency can be selected to evaporate material more quickly (e.g., at a higher Er) when analyzing a more homogenous or more robust region.

FIG. 13 is a flow diagram illustrating a process for controlling an evaporation process in an atom probe in accordance with certain embodiments of the invention. The process can include evaporating material from a specimen at a first evaporation rate and a first value of a pulse frequency (process portion 1302) and monitoring a parameter associated with material being evaporated (process portion 1304). The process can further include evaporating material from the specimen at a second evaporation rate with a second value of the pulse frequency (process portion 1306).

For example, in selected embodiments a method for controlling an evaporation process in an atom probe can include evaporating material from a specimen during the atom probe evaporation process at a first evaporation rate and a first value of a pulse frequency. The method can further include monitoring a parameter associated with material being evaporated from the specimen during the atom probe evaporation process. The method can still further include evaporating material from the specimen at a second evaporation rate with a second value of the pulse frequency, wherein the second value is different than the first.

In selected embodiments the first evaporation rate can be at least approximately equal to the second evaporation rate. In other embodiments, the first evaporation rate can be different than the second evaporation rate. Additionally, in certain embodiments monitoring a parameter associated with the material being evaporated can include monitoring the evaporation rate of the material being evaporated from the specimen, a mass resolution for the specimen, and/or a composition of the material being evaporated from the specimen.

In still other embodiments, the material being evaporated can include a first type of material and a second type of material, and monitoring a parameter associated with material being evaporated can include monitoring a rate that the first type of material is being evaporated from the specimen and/or monitoring the rate that the first type of material is being evaporated as compared to the rate that the second type of material is being evaporated. In yet other embodiments, a computing system can be used to monitor a parameter associated with material being evaporated from the specimen during the atom probe evaporation process and/or to automatically change the pulse frequency from the first value to the second value (e.g., in response to the monitored parameter(s)).

In yet other embodiments of the invention, an evaporation rate control process may be change from one mode of operation to another (e.g., from one of the process discussed above to another) depending upon parameters detected during the analysis. For example, in selected embodiments, when an interface is detected such that a material with an evaporation field substantially different from the primary material becomes exposed to the surface of the specimen, the prevailing mode of controlling the evaporation process may shift from a feedback loop where evaporation rate governs specimen voltage to a mode where the specimen voltage is held substantially constant while pulse fraction or pulse energy is adjusted to continue the evaporation process. Upon completion of the analysis of this interface layer, the system may return to the original, prevailing, or default mode of operation.

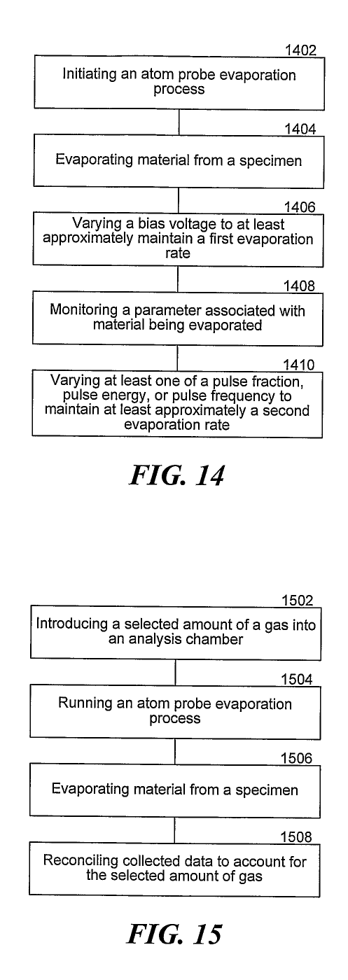

FIG. 14 is a flow diagram illustrating a process for controlling an evaporation process in an atom probe in accordance with selected embodiments of the invention. The process can include initiating an atom probe evaporation process (process portion 1402), evaporating material from a specimen (process portion 1404), and varying a bias voltage to at least approximately maintain a first evaporation rate (process portion 1406). The process can further include monitoring a parameter associated with material being evaporated (process portion 1408) and varying at least one of a pulse fraction, pulse energy, or pulse frequency to maintain at least approximately a second evaporation rate (process portion 1410).

For example, in selected embodiments a method for controlling an evaporation process in an atom probe can include initiating the atom probe evaporation process of a specimen, evaporating material from the specimen, and varying a bias voltage to at least approximately maintain a first evaporation rate. The method can further include monitoring a parameter associated with material being evaporated from the specimen at the at least approximately the first evaporation rate, and varying a pulse fraction, pulse energy, and/or pulse frequency to maintain at least approximately a second evaporation rate.

In certain embodiments, monitoring a parameter associated the material being evaporated can include monitoring at least one of a mass resolution and a composition of the material being evaporated from the specimen. In other embodiments, the material being evaporated can include a first type of material and a second type of material, and monitoring a parameter associated with material being evaporated can include monitoring a rate that the first type of material is being evaporated from the specimen and/or monitoring the rate that the first type of material is being evaporated as compared to the rate that the second type of material is being evaporated. In still other embodiments, a computing system can be used to automatically vary a bias voltage to at least approximately maintain a first evaporation rate, to monitor a parameter associated with material being evaporated from the specimen at the at least approximately the first evaporation rate, and/or to automatically vary at least one of the pulse fraction, pulse energy, or pulse frequency to maintain at least approximately a second evaporation rate.

In still other embodiments of the invention, a small amount of a gas (e.g. Hydrogen [“H”], an inert gas, a non-inert gas, and/or the like) can be introduced into an atom probe analysis chamber to modulate the evaporation threshold (e.g., the effective field (in volts/nm) required to induce field evaporation). For example, in selected embodiments the Hydrogen can be introduced via the fluid control system discussed above with reference to FIG. 1 and can lower the evaporation threshold; thereby decreasing stress on the specimen during analysis. In some embodiments, because Hydrogen can take a long time to pump in/pump out of the analysis chamber, the entire experiment can be run in this mode.

FIG. 15 is a flow diagram illustrating a process for controlling an evaporation process in an atom probe in accordance with certain embodiments of the invention. The process can include introducing a selected amount of a gas into an analysis chamber (process portion 1502), running an atom probe evaporation process (process portion 1504), and evaporating material from a specimen (process portion 1506). In selected embodiments, the process can further include reconciling collected data to account for the selected amount of gas (process portion 1508).

For example, in selected embodiments a method for controlling an evaporation process in an atom probe can include introducing a selected amount of a gas into an analysis chamber of an atom probe to lower the energy required to evaporate material from a specimen during an atom probe evaporation process. The method can further include running an atom probe evaporation process and evaporating material from the specimen. In certain embodiments, the gas can include hydrogen. In still other embodiments, the method can further include reconciling data collected during the atom probe evaporation process to account for the selected amount of gas. For example, in certain embodiments a computing system can be used to “subtract out” the affects that the gas has on the data.

From the foregoing, it will be appreciated that specific embodiments of the invention have been described herein for purposes of illustration, but that various modifications may be made without deviating from the invention. Additionally, aspects of the invention described in the context of particular embodiments may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/We claim:

1. A method for controlling an evaporation process in an atom probe, comprising:
initiating the atom probe evaporation process of a specimen;
monitoring a parameter associated with material being evaporated from a selected portion of a field of view of the specimen during the atom probe evaporation process, the selected portion of the field of view being less than the entire field of view; and
controlling at least one characteristic of the atom probe evaporation process to attain at least approximately a desired evaporation rate for the selected portion.

2. The method of claim 1 wherein:
monitoring a parameter includes using a computing system to monitor a parameter associated with material being evaporated from a selected portion of a field of view of the specimen during the atom probe evaporation process; and
controlling at least one characteristic includes using the computing system to automatically control the at least one characteristic based on the parameter associated with material being evaporated.

3. The method of claim 1 wherein the selected portion of the field of view includes a first section and a second section spaced apart from the first section, the first and second sections being noncontiguous.

4. The method of claim 1 wherein controlling at least one characteristic of the atom probe evaporation process includes controlling at least one of a pulse energy, a pulse frequency, and a bias energy.

5. The method of claim 1 wherein monitoring a parameter includes monitoring at least one of the evaporation rate of the material being evaporated from the selected portion of the field of view of the specimen, a mass resolution for the selected portion of the field of view of the specimen, and a composition of the material being evaporated from the selected portion of the field of view of the specimen.

6. The method of claim 1 wherein the material being evaporated includes a first type of material and a second type of material, and wherein monitoring a parameter includes at least one of monitoring a rate that the first type of material is being evaporated from the selected portion of the field of view of the specimen and monitoring the rate that the first type of material is being evaporated as compared to the rate that the second type of material is being evaporated.

7. The method of claim 1 wherein the material being evaporated results in ions hitting a detector and wherein monitoring a parameter includes monitoring mass-to-charge ratios of the detected ions and determining if any of the mass-to-charge ratios being monitored are at least approximately equal to one or more selected values.

8. The method of claim 1 wherein the material being evaporated results in ions hitting a detector and wherein monitoring a parameter includes monitoring mass-to-charge ratios of the detected ions and determining a rate that ions having mass-to-charge ratios at least approximately equal to one or more selected values are detected by the detector.

9. The method of claim 1 wherein the material being evaporated results in first ions hitting a detector and second ions hitting the detector, the first ions having a first mass-to-charge ratio and the second ions having a second mass-to-charge ratio, and wherein monitoring a parameter includes comparing a rate at which the first ions are detected by the detector to the rate at which the second ions are detected by the detector.

10. A method for controlling an evaporation process in an atom probe, comprising:
initiating the atom probe evaporation process of a specimen to evaporate material from the specimen, the material being evaporated resulting in ions hitting a detector;
monitoring mass-to-charge ratios of the detected ions;
determining if any of the mass-to-charge ratios being monitored are at least approximately equal to one or more selected values; and
controlling at least one characteristic of the atom probe evaporation process to attain at least approximately a desired evaporation rate based on the mass-to-charge ratios being monitored.

11. The method of claim 10, further comprising determining a rate that ions having mass-to-charge ratios at least approximately equal to one or more selected values are detected by the detector.

12. The method of claim 10 wherein the material being evaporated results in first ions hitting a detector and second ions hitting the detector, and wherein the first ions have a first mass-to-charge ratio at least approximately equal to a first selected value and the second ions have a second mass-to-charge ratio at least approximately equal to a second selected value, and wherein the method further comprises comparing a rate at which the first ions are detected by the detector to the rate at which the second ions are detected by the detector.

13. The method of claim 10 wherein controlling at least one characteristic of the atom probe evaporation process includes controlling at least one of a pulse energy, a pulse frequency, and a bias energy.

14. The method of claim 10 wherein:
monitoring mass-to-charge ratios includes using a computing system to monitor mass-to-charge ratios of the detected ions;
determining if any of the mass-to-charge ratios being monitored are at least approximately equal to one or more selected values includes using the computing system to determine if any of the mass-to-charge ratios being monitored are at least approximately equal to one or more selected values; and
controlling at least one characteristic includes using the computing system to control at least one characteristic of the atom probe evaporation process to attain at least approximately a desired evaporation rate based on the mass-to-charge ratios being monitored.

15. A method for controlling an evaporation process in an atom probe, comprising:
initiating the atom probe evaporation process of a specimen to evaporate material from the specimen;
establishing at least approximately a first evaporation rate;
reducing a pulse energy being applied to the specimen from a first pulse energy value associated with the first evaporation rate to a second pulse energy value; and
decreasing a bias energy being applied to the specimen from a first bias energy value associated with the first evaporation rate to a second bias energy value associated with a second evaporation rate.

16. The method of claim 15, further comprising increasing the pulse energy from at least approximately the second pulse energy value to a third pulse energy value after the bias energy has been established at the second bias energy value, the third pulse energy value being associated with the second evaporation rate.

17. The method of claim 15 wherein the bias energy is a bias voltage.

18. The method of claim 15 wherein the pulse energy is at least one of an electrical pulse and a photonic energy pulse.

19. The method of claim 15 wherein the second evaporation rate is less than the first evaporation rate.

20. The method of claim 15 wherein the second evaporation rate is at least approximately the same as the first evaporation rate.

21. The method of claim 15 wherein establishing at least approximately a first evaporation rate includes using a computer to establish at least approximately a first evaporation rate, and wherein the method further comprises using a computing system to receive a user command to at least one of establish at least approximately the second evaporation rate and to establish at least approximately the second bias energy value, and wherein:
reducing a pulse energy being applied includes using a computing system to automatically reduce a pulse energy being applied to the specimen in response to the user command; and
decreasing a bias energy being applied includes using the computing system to automatically decrease a bias energy based on the user command.

22. The method of claim 15, further comprising using a computing system to determine a need to at least one of establish at least approximately the second evaporation rate and to establish at least approximately the second bias energy value, and wherein:
reducing a pulse energy being applied includes using the computing system to automatically reduce a pulse energy being applied to the specimen; and
decreasing a bias energy being applied includes using the computing system to automatically decrease a bias energy.

23. The method of claim 15 further comprising (1) using a computing system to receive a user command to at least one of establish at least approximately the second evaporation rate and to establish at least approximately the second bias energy value or (2) the computing system determines a need to at least one of establish at least approximately the second evaporation rate and to establish at least approximately the second bias energy value, wherein:
reducing a pulse energy being applied includes using a computing system to automatically reduce a pulse energy being applied to the specimen;
decreasing a bias energy being applied includes using the computing system to automatically decrease a bias energy; and
the method further comprises the computing system increasing the pulse energy from at least approximately the second pulse energy value to a third pulse energy value after the bias energy has been established at the second bias energy value, the third pulse energy value being associated with the second evaporation rate.

24. The method of claim 15 wherein the pulse energy includes photonic energy and wherein reducing a pulse energy being applied to the specimen includes preventing at least a portion of the photonic beam from reaching the specimen.

25. The method of claim 15 wherein the pulse energy includes photonic energy and wherein reducing a pulse energy being applied to the specimen includes at least one of blocking at least a portion of a photonic beam, modulating a polarity of at least a portion of the photonic beam, steering at least a portion of the photonic beam away from the specimen, and defocusing at least a portion of the photonic beam.

26. A method for controlling an evaporation process in an atom probe, comprising:
evaporating material from a specimen during the atom probe evaporation process at a first evaporation rate and a first value of a pulse fraction;
monitoring a parameter associated with material being evaporated from the specimen during the atom probe evaporation process; and
evaporating material from the specimen at a second evaporation rate with a second value of the pulse fraction, the second value being different than the first.

27. The method of claim 26 wherein the first evaporation rate is at least approximately equal to the second evaporation rate.

28. The method of claim 26 wherein:
monitoring a parameter includes using a computing system to monitor a parameter associated with material being evaporated from the specimen during the atom probe evaporation process; and
evaporating material from the specimen includes using the computing system to automatically change the pulse fraction from the first value to the second value.

29. The method of claim 26 wherein monitoring a parameter includes monitoring at least one of the evaporation rate of the material being evaporated from the specimen, a mass resolution for the specimen, and a composition of the material being evaporated from the specimen.

30. The method of claim 26 wherein the material being evaporated includes a first type of material and a second type of material, and wherein monitoring a parameter includes at least one of monitoring a rate that the first type of material is being evaporated from the specimen and monitoring the rate that the first type of material is being evaporated as compared to the rate that the second type of material is being evaporated.

31. A method for controlling an evaporation process in an atom probe, comprising:
evaporating material from a specimen during the atom probe evaporation process at a first evaporation rate and a first value of a pulse frequency;
monitoring a parameter associated with material being evaporated from the specimen during the atom probe evaporation process; and
evaporating material from the specimen at a second evaporation rate with a second value of the pulse frequency, the second value being different than the first.

32. The method of claim 31 wherein the first evaporation rate is at least approximately equal to the second evaporation rate.

33. The method of claim 31 wherein:
monitoring a parameter includes using a computing system to monitor a parameter associated with material being evaporated from the specimen during the atom probe evaporation process; and
evaporating material from the specimen includes using the computing system to automatically change the pulse frequency from the first value to the second value.

34. The method of claim 31 wherein monitoring a parameter includes monitoring at least one of the evaporation rate of the material being evaporated from the specimen, a mass resolution for the specimen, and a composition of the material being evaporated from the specimen.

35. The method of claim 31 wherein the material being evaporated includes a first type of material and a second type of material, and wherein monitoring a parameter includes at least one of monitoring a rate that the first type of material is being evaporated from the specimen and monitoring the rate that the first type of material is being evaporated as compared to the rate that the second type of material is being evaporated.

36. A computer implemented method for controlling an evaporation process in an atom probe, comprising:
receiving multiple selected values for setting a pulse fraction in an atom probe;
controlling the atom probe to produce the pulse fraction associated with each of the selected values; and
monitoring a parameter associated with an evaporation of material from a specimen for each of the produced pulse fractions.

37. The method of claim 36, further comprising determining which selected value is associated with a desired parameter.

38. The method of claim 36 wherein monitoring a parameter includes monitoring at least one of an evaporation rate associated with material being evaporated from a specimen and a mass resolution associated with material being evaporated from a specimen.

39. A method for controlling an evaporation process in an atom probe, comprising:
introducing a selected amount of a gas into an analysis chamber of an atom probe to lower the energy required to evaporate material from a specimen during an atom probe evaporation process; and
running an atom probe evaporation process; and
evaporating material from the specimen.

40. The method of claim 39 wherein the gas includes hydrogen.

41. The method of claim 39, further comprising reconciling data collected during the atom probe evaporation process to account for the selected amount of gas.

42. A method for controlling an evaporation process in an atom probe, comprising:
initiating the atom probe evaporation process of a specimen;
evaporating material from the specimen;
varying a bias voltage to at least approximately maintain a first evaporation rate;
monitoring a parameter associated with material being evaporated from the specimen at the at least approximately the first evaporation rate; and
varying at least one of a pulse fraction, pulse energy, or pulse frequency to maintain at least approximately a second evaporation rate.

43. The method of claim 42 wherein:
varying a bias voltage includes using a computing system to automatically vary a bias voltage to at least approximately maintain a first evaporation rate;
monitoring a parameter includes using a computing system to monitor a parameter associated with material being evaporated from the specimen at the at least approximately the first evaporation rate; and
varying at least one of the pulse fraction, pulse energy, or pulse frequency includes using a computer to automatically vary at least one of the pulse fraction, pulse energy, or pulse frequency to maintain at least approximately a second evaporation rate.

44. The method of claim 42 wherein monitoring a parameter includes monitoring at least one of a mass resolution and a composition of the material being evaporated from the specimen.

45. The method of claim 42 wherein the material being evaporated includes a first type of material and a second type of material, and wherein monitoring a parameter includes at least one of monitoring a rate that the first type of material is being evaporated from the specimen and monitoring the rate that the first type of material is being evaporated as compared to the rate that the second type of material is being evaporated.
